(19) United States
(12) Patent Application Publication
(10) Pub. No.: US 2020/0158471 A1
(43) Pub. Date: May 21, 2020

(54) ARTILLERY UNIT CONTROL PANEL EMULATOR INTEGRATION WITH TRAINING SYSTEM

(71) Applicant: Cubic Corporation, San Diego, CA (US)

(72) Inventors: Martyn Armstrong, Salisbury (GB); Neale Smiles, Salisbury (GB); Alastair Parkinson, Salisbury (GB); John Gardiner, Manchester (GB); Jason Mayo, Medstead (GB); Robert Spriggs, Melksham (GB)

(21) Appl. No.: 16/679,668

(22) Filed: Nov. 11, 2019

Related U.S. Application Data
(60) Provisional application No. 62/769,069, filed on Nov. 19, 2018.

(51) Int. Cl. F41G 3/26; G09B 9/00; F41A 33/00

(52) U.S. Cl. CPC F41G 3/265; G09B 9/003; F41G 3/2638; F41A 33/00; G09B 9/006

(57) ABSTRACT

Systems and methods for interfacing an artillery unit control panel emulator with a collective training environment are disclosed. One method includes reading output data including one or more output data segments generated by the artillery unit control panel emulator. The method includes examining the output data to identify a trigger event in the one or more output data segments. The method includes extracting details regarding the trigger event from the one or more output data segments. The method includes creating a message indicative of the trigger event and including the details regarding the trigger event. The method includes sending, via a communication interface, the message to a device within the collective training environment.

### CROSS-REFERENCES TO RELATED APPLICATIONS

This application claims the benefit of U.S. Provisional Patent Application No. 62/769,069, filed Nov. 19, 2018, entitled “MLRS and HIMARS LVC Training Interface Application—ROcket Virtual Effects Reader (ROVER),” which is assigned to the assignee hereof and incorporated by reference herein in its entirety.

### BACKGROUND

Embodiments of the invention(s) described herein are generally related to artillery training and Live, Virtual, and Constructive (LVC) simulation training environments for the military, such as tactical engagement simulation (TES) and others. That said, a person of ordinary skill in the art will understand that alternative embodiments may vary from the embodiments discussed herein, and alternative applications may exist (e.g., using weapons other than artillery and/or applications outside of military training environments.).

In traditional training environments, artillery units (such as High Mobility Artillery Rocket System (HIMARS) and Multiple Launch Rocket System (MLRS)) play little part in the TES battle when training, despite providing battle-winning, “first strike” capability. They are rarely integrated with force-on-force training due to the complexities of the platform and the difficulty of integration with on-board fire control systems. Given current and future threats, the ability of multi-national artilleries to train in an interoperable manner is of paramount importance, yet it does not currently happen. Instead, artillery units typically engage in classroom procedural training in which on-board fire control systems are emulated on a computer display, with little or no simulated communication with other types of units on the battlefield.

### BRIEF SUMMARY

Embodiments of the present invention offer an affordable, technologically simple, yet innovative method of bringing rocket and missile fires into NATO and partner-Nation fires training, which may help to realize the US Army's ambition to provide Theater Fires Command and Control in Europe. According to embodiments, a software application (herein referred to as the ROcket Virtual Effects Reader (ROVER) application) may interface with existing training software applications to allow the existing training software applications to integrate into LVC training, such as TES.

A summary of the invention is provided below with respect to a series of examples. As used below, any reference to a series of examples is to be understood as a reference to each of those examples disjunctively (e.g., “Examples 1-4” is to be understood as “Examples 1, 2, 3, or 4”).

Example 1 is a method of interfacing an artillery unit control panel emulator with a collective training environment, the method comprising: reading output data generated by the artillery unit control panel emulator, wherein the output data includes one or more output data segments; examining the output data to identify a trigger event in the one or more output data segments; extracting details regarding the trigger event from the one or more output data segments; creating a message indicative of the trigger event and including the details regarding the trigger event; and sending, via a communication interface, the message to a device within the collective training environment.

Example 2 is the method of example(s) 1, wherein the trigger event comprises at least one of: a simulated arming of an artillery unit, a simulated firing of the artillery unit; or a detonation of a round based on the simulated firing of the artillery unit.

Example 3 is the method of example(s) 1, wherein the device within the collective training environment is a collective training environment server.

Example 4 is the method of example(s) 1, wherein the artillery unit control panel emulator is associated with a rocket or missile artillery unit.

Example 5 is the method of example(s) 1, wherein the artillery unit control panel emulator is executed on a training computer system that includes a processing unit communicatively coupled to a memory and the communication interface, wherein the training computer system is separate from the device within the collective training environment.

Example 6 is the method of example(s) 1, wherein extracting the details regarding the trigger event from the one or more output data segments is performed in response to identifying the trigger event.

Example 7 is the method of example(s) 1, wherein the output data is read from an output data repository of a training computer system on which the artillery unit control panel emulator is executed.

Example 8 is the method of example(s) 1, wherein the message comprises a distributed interactive simulation (DIS) message.

Example 9 is the method of example(s) 1, further comprising: receiving, via the communication interface, information from a second device separate from a training computer system on which the artillery unit control panel emulator is executed; and updating information within the artillery unit control panel emulator based, at least in part, on the information received from the second device.

Example 10 is a training computer system for interfacing an artillery unit control panel emulator with a collective training environment, the system comprising: a communication interface; a memory; and a processing unit communicatively coupled with the memory and the communication interface and configured to perform operations comprising: reading output data generated by the artillery unit control panel emulator, wherein the output data includes one or more output data segments; examining the output data to identify a trigger event in the one or more output data segments; extracting details regarding the trigger event from the one or more output data segments; creating a message indicative of the trigger event and including the details regarding the trigger event; and sending, via the communication interface, the message to a device within the collective training environment.

Example 11 is the training computer system of example(s) 10, wherein the trigger event comprises at least one of: a simulated arming of an artillery unit, a simulated firing of the artillery unit; or a detonation of a round based on the simulated firing of the artillery unit.

Example 12 is the training computer system of example(s) 10, wherein the device within the collective training environment is a collective training environment server.

Example 13 is the training computer system of example(s) 10, wherein extracting the details regarding the trigger event from the one or more output data segments is performed in response to identifying the trigger event.

Example 14 is the training computer system of example(s) 10, wherein the message comprises a distributed interactive simulation (DIS) message.

Example 15 is the training computer system of example(s) 10, wherein the operations further comprise: receiving, via the communication interface, information from a second device separate from a training computer system on which the artillery unit control panel emulator is executed; and updating information within the artillery unit control panel emulator based, at least in part, on the information received from the second device.

Example 16 is a non-transitory computer-readable medium comprising instructions for interfacing an artillery unit control panel emulator with a collective training environment, wherein the instructions, when executed by one or more processors, cause the one or more processors to perform operations comprising: reading output data generated by the artillery unit control panel emulator, wherein the output data includes one or more output data segments; examining the output data to identify a trigger event in the one or more output data segments; extracting details regarding the trigger event from the one or more output data segments; creating a message indicative of the trigger event and including the details regarding the trigger event; and sending, via a communication interface, the message to a device within the collective training environment.

Example 17 is the non-transitory computer-readable medium of example(s) 16, wherein the trigger event comprises at least one of: a simulated arming of an artillery unit, a simulated firing of the artillery unit; or a detonation of a round based on the simulated firing of the artillery unit.

Example 18 is the non-transitory computer-readable medium of example(s) 16, wherein the device within the collective training environment is a collective training environment server.

Example 19 is the non-transitory computer-readable medium of example(s) 16, wherein the message comprises a distributed interactive simulation (DIS) message.

Example 20 is the non-transitory computer-readable medium of example(s) 16, wherein the operations further comprise: receiving, via the communication interface, information from a second device separate from a training computer system on which the artillery unit control panel emulator is executed; and updating information within the artillery unit control panel emulator based, at least in part, on the information received from the second device.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is a simplified illustration of an artillery unit training system, according to some embodiments;

FIG. 2 is a simplified illustration of a collective training environment, which may correspond to a tactical engagement simulation (TES), according to some embodiments;

FIG. 3 is a simplified block diagram of the internal components of a military communications unit, according to some embodiments;

FIG. 4 is a simplified illustration of a training computer system, according to some embodiments;

FIG. 5 is a flow diagram of a method of interfacing an artillery unit control panel emulator with a collective training environment, according to some embodiments; and

FIG. 6 is a simplified block diagram of a computer system, according an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label irrespective of the second reference label.

### DETAILED DESCRIPTION

The ensuing description provides embodiments only, and is not intended to limit the scope, applicability or configuration of the disclosure. Rather, the ensuing description of the embodiments will provide those skilled in the art with an enabling description for implementing an embodiment. It is understood that various changes may be made in the function and arrangement of elements without departing from the scope.

It can be noted that the embodiments provided herein can be used to provide immersive training for various artillery units without firing any live rounds, or necessarily providing training using physical artillery vehicles. As such, use of the terms “artillery units” and “artillery vehicles” and the like, refer to simulated artillery vehicles, as used in classroom training or other training environments.

Some embodiments provided herein describe a software application (herein referred to as the ROcket Virtual Effects Reader (ROVER) application) that may interface with existing training software applications for artillery units to allow them to integrate into Live, Virtual, and Constructive (LVC) trainings for the military, such as tactical engagement simulation (TES). In some instances, the software application may examine output data produced by the training software application to identify a trigger event, which may correspond to a simulated firing of an artillery unit. In response to identifying the trigger event, the software application may extract details regarding the trigger event from various output data segments and communicate the extracted details to various components of an artillery unit training system.

Techniques described can utilize a cellular-based communications unit connected to one or more inertial measurement devices and a vibrationally-tuned trigger, in order to instrument a Multiple Launch Rocket System (MLRS), High Mobility Artillery Rocket System (HIMARS), or similar system for training in a tactical engagement simulation (TES) environment. Systems for doing so may be referred to herein as TES Acoustic Rocket And Missile Offensive Support System (ARMOSS). Embodiments may further utilize open-architecture Distributed Interactive Simulation (DIS)/Higher Level Architecture (HLA) packet translator to then pass highly accurate and timely engagement data to the wider TES system using the cellular-based communications unit.

It can be noted that, although some embodiments provided herein describe a communications unit using LTE Long Term Evolution (LTE) or other cellular technology, other wireless technologies can be used in addition or as an alternative to LTE/cellular to communicate with a wide area network (WAN) or other digital communication network. These technologies can include, for example, fifth-generation (5G) New Radio (NR) or Nth Generation (NG) wireless standards and protocols. A person of ordinary skill in the art will appreciate that such standards evolve, and that new equivalent standards may take their place.

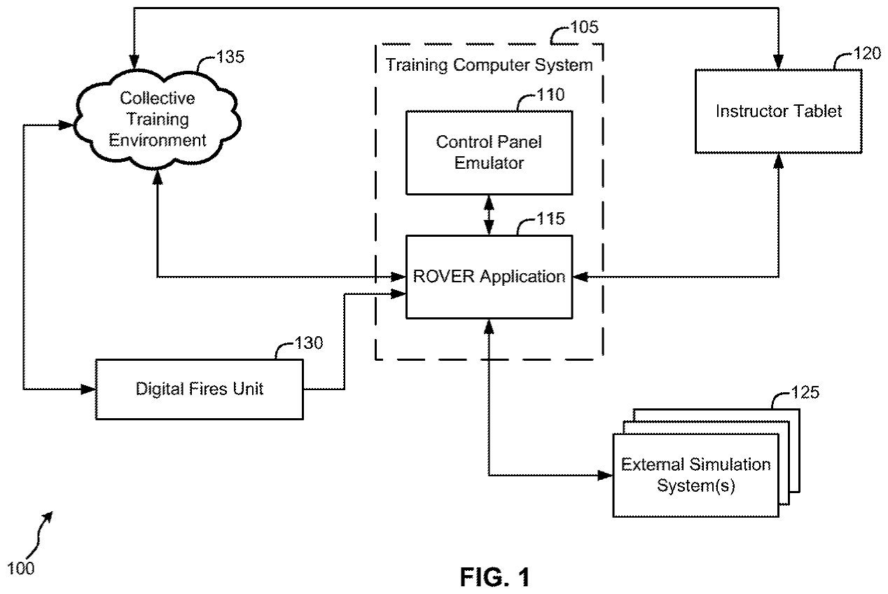

FIG. 1 is a simplified illustration of an artillery unit training system 100, according to some embodiments. As previously noted, training for artillery units is typically done without interaction with any other types of military units on the battlefield (e.g., infantry, tanks, aircraft, etc.). Instead, training is often limited to procedural training conducted in the classroom, in which a training computer system 105, such as a personal computer (PC), executes a control panel emulator 110 or similar training software in which all or a portion of a physical control panel (typically located within the cab of the artillery unit) of an artillery unit is displayed on a computer display of training computer system 105.

Traditional training setups involve little more than this. Students can then conduct procedural training of various fire missions using training computer system 105. Traditional control panel emulators may further provide some limited capabilities in which an instructor can interact with students. This, however, limits training and interaction with other military units. Although artillery units such as MLRS and HIMARS are “at range,” and are therefore rarely ever located the same space as troops or other military units who would call for fire support, comprehensive artillery unit training may still need to integrate procedural training with interaction with other military units.

According to embodiments herein, ROVER application 115 can interface with control panel emulator 110 to expand artillery training far beyond the current capabilities of control panel emulator 110. As illustrated in FIG. 1, ROVER application 115 may be executed on training computer system 105 and may communicate not only with control panel emulator 110, but also with an instructor tablet 120, one or more external simulation systems 125, a digital fires unit 130, and/or a collective training environment 135, each of which may comprise one or more computer systems communicatively coupled with training computer system 105. (Arrows in FIG. 1 represent communication links between the various components.) In so doing, ROVER application 115 enables training computer system 105 to permit crews to carry out fire missions in a fully integrated manner for any collective training event conducted in collective training environment 135.

That said, it can be noted that alternative configurations of artillery unit training system 100 may exclude different components (such as instructor tablet 120, external simulation system(s) 125, digital fires unit 130, and/or collective training environment 135) as needed. Classroom procedural training may be performed, for example, without the need to communicate with collective training environment 135 and/or digital fires unit 130, and yet may be enhanced over traditional classroom trainings via the additional capabilities provided by ROVER application 115 to communicate with instructor tablet 120 and/or external simulation system(s) 125. Other types of training may utilize yet other configurations. In some embodiments, for example, in addition or as an alternative to sending information to collective training environment 135, ROVER application 115 may send similar information to a classroom simulator, such as Simulation IG.

ROVER application 115 may interface with control panel emulator 110 in any of a variety of ways. For instance, Fire Control Panel Trainer (FCPT) is a control panel emulator that writes text to a log file over the course of a training. ROVER application 115 may parse through this log file, as it is written throughout a training, to identify certain events and communicate pertinent information to other devices and/or systems in training environment 100, such as instructor tablet 120 and collective training environment 135. Put differently, ROVER application 115 can act as a software gateway to connect an existing control panel emulator 110 with a wider training ecosystem. This can, for example, allow trainees to receive input regarding the consequences of actions taken by the artillery unit, rather than simply receive a “pass” or “fail” grade in a procedural training program.

Training on training computer system 105 may require trainees to input a fire mission into training computer system 105 using control panel emulator 110. Traditionally, the fire mission may be received via a physical paper or voice command. However, ROVER application 115 may additionally be configured to provide inputs to control panel emulator 110, allowing ROVER application 115 to provide fire mission information digitally, which may represent real-world scenarios in many situations. That is, ROVER application 115 may receive fire missions digitally from instructor tablet 120 and/or a separate digital fires unit 130 (which may simulate instructions from a command post), and then put the fire mission data into control panel emulator 110.

In some embodiments, ROVER application 115 may additionally or alternatively provide voice communications via training computer system 105. That is, ROVER application 115 may enable an instructor to use instructor tablet 122 to provide voice communications to training computer system 105 (which may be one-way or two-way, depending on desired functionality), allowing the instructor to provide a fire mission (and/or other audio communication) to trainees using training computer system 105.

Collective training environment 135 may comprise an LVC simulation training environment, such as TES, and may therefore provide a training environment for many different types of military entities. In some embodiments, for example, collective training environment 135 may orchestrate large simulated battles between many different military entities, which may be of various different types (infantry, aircraft, ground vehicles, etc.). Thus, many entities (not shown in FIG. 1, but which may number in the dozens, hundreds, thousands, etc.) may be in communication with collective training environment 135 during simulated battles. In some embodiments, instructor tablet 120 and/or digital fires unit 130 may receive a visualization or other data from a battle simulated by collective training environment 135, and the instructor and/or digital fires unit user may provide fire missions to trainees on training computer system 105 digitally and/or audibly. When trainees receive the fire mission, they can enter the fire mission into control panel emulator 110, and verify and execute the mission accordingly.

Over the course of the fire mission, ROVER application 115 can parse through the log file generated by control panel emulator 110 to detect certain data indicative of events that may impact the simulated battle, then send messages back to collective training environment 135 indicating that those certain events have taken place.

In some embodiments, this may involve reformatting data to ensure messages are provided to collective training environment 135 in a proper format. In some embodiments, for example, messages may comprise protocol data units (PDUs) conveying information regarding certain events. Accordingly, ROVER application 115 may parse the log file created by control panel emulator 110 and create and send various PDUs to collective training environment 135 representative of certain actions taken by the artillery unit, as entered into control panel emulator 110.

Information provided by ROVER application 115 to collective training environment 135 may vary, depending on desired functionality. In some embodiments, for example, ROVER application 115 may send a message to collective training environment 135 of a location of the artillery unit (as simulated by control panel emulator 110). The location of the artillery unit may be provided, for example, when the artillery unit “moves” to a particular location (e.g., as simulated within control panel emulator 110 or an external simulation system 125, as described in further detail below) and/or at other points during a fire mission. Other messages may include when the artillery unit “fires” and when the fired round (e.g., missile) “detonates” (as simulated from actions taken in control panel emulator 110).

The information carried in the message sent from ROVER application 115 to collective training environment 135 when the artillery unit fires may vary, depending on the needs of collective training environment 135, the information provided in the log file of the control panel emulator 110, and/or other factors. In some embodiments, for example, ROVER application 115 can detect the firing from the log file (considered a “shot” in artillery terms) and calculate the direction and trajectory of the missile. The calculation may take into account various effects (e.g., weather, which may vary depending on the type of round fired), and may be based on information such as location and orientation of the artillery unit vehicle and/or launch module. This calculation may be sent to collective training environment 135 to indicate the firing of the artillery unit, and may be accompanied by additional information such as location and orientation of the artillery unit and/or launch module, trajectory of the round, and the like.

In some embodiments, ROVER application 115 may provide a separate message indicating detonation of the round. This information may be determined by ROVER application 115 based on the distance of the artillery unit from the target and the trajectory of the round, which may be provided in, or determined from, data found in the log file of control panel emulator 110. Because this information can impact other units in the simulated battlefield orchestrated by collective training environment 135, this message can be particularly important. For example, entities at or near the target at the time of detonation may be disabled or destroyed, and the simulated battlefield can be updated accordingly.

The data included in the firing and/or the detonation messages can be particularly useful in collective training environment 135 to help provide accuracy in the simulated battlefield. For example, trajectory data included in the firing or detonation messages may enable collective training environment 135 to determine whether the path of trajectory is clear or whether an entity (e.g., an aircraft) or other obstacle is in the way. In such instances, instead of detonating the fired round at the location computed by ROVER application 115, collective training environment 135 may determine that the round struck the obstacle, and may choose to detonate the round at or near the location of the obstacle.

Depending on desired functionality, ROVER application 115 may provide similar messages to instructor tablet 120 as described above, although they may be formatted differently. In some embodiments, however, ROVER application 115 may provide a more granular level of information to instructor tablet 120, to enable an instructor to closely follow the firing mission emulated on control panel emulator 110. As such, additional information may be provided to instructor tablet 120 that may not be provided to collective training environment 135. This level of granularity may be configurable by the instructor or some other user, in some embodiments. For example, ROVER application 115 may provide instructor tablet 120 with a message after a fire mission is entered into control panel emulator 110 and validated, to determine whether it was entered correctly. Additional messages may include information regarding a change in the direction the launcher module is pointed, when the artillery unit is armed, when it is fired, the calculated detonation time and location, and the like. Ultimately, ROVER application 115 can be configured to provide instructor tablet 120 with enough data to provide a “command vs. actual” analysis to determine any differences in what trainees were commanded to do vs. what they did (highlighting, for example, errors in bearing, firing, etc.).

It can be noted that although an instructor “tablet” 120 is illustrated in FIG. 1, embodiments may include other types of computing systems, depending on desired functionality. In alternative embodiments, for example, instructor tablet 120, training computer system 105, and/or other components illustrated in FIG. 1, may be executed by various types of computer systems, including computer servers, laptops, desktops, tablets, mobile phones, and the like.

As previously indicated, the format in which ROVER application 115 provides instructor tablet 120 information may vary, depending on desired functionality. In some embodiments, for example, ROVER application 115 may send information in DIS/HLA PDU format. Additionally or alternatively, ROVER application 115 may send information in open source map formats according to a geographical information system (GIS). This can enable instructor tablet 120 (or other device to which the GIS information is sent) to visually represent what has been fired, allowing an instructor to see visually the firing of the round.

The functionality of instructor tablet 120 may vary, depending on desired functionality. In some embodiments, for example, instructor tablet 120 may execute a software application that enables an instructor using instructor tablet 120 to interact with trainees on training computer system 105 in real-time, as the trainees are conducting training on control panel emulator 110. ROVER application 115 can provide this interface between instructor tablet 120 and control panel emulator 110. In some embodiments, for example, an instructor may be able to provide any of a variety of failures over the course of a training, to cause control panel emulator 110 to simulate failures such as a power failure, component failure, missile misfire, hang fire, etc. additionally or alternatively, the instructor may be capable of stopping or pausing training on training computer system 105 by using instructor tablet 120 (e.g., by providing an input that relays information to ROVER application 115, which pauses training on control panel emulator 110).

External simulation system(s) 125 may comprise one or more additional simulators, local to trainees, that may be used in conjunction with control panel emulator 110, which may help make training more immersive. Currently, FCPT (a control panel emulator 110) provides users with a simple drop-down menu to move the artillery unit, change its heading, reload ammunition, and input crypto. Of course, simply selecting these activities on a drop-down menu of control panel emulator 110 fails to provide immersive training for any of these activities. Thus, according to embodiments, one or more external simulation systems 125 may comprise separate devices (e.g., comprising hardware and/or software) configured to provide training for such activities, or other activities for which artillery unit trainees may need to train, and ROVER application 115 can communicate information to and/or from external simulation system(s) 125, to provide for more immersive training.

Moving and/or changing the heading of an artillery unit, for example, can be provided by a software application executed on external simulation system 125 comprising a computer system having one or more displays showing a visualization of a viewpoint from a driver position of the artillery unit. Furthermore, a steering wheel, pedals, and/or other physical controls may be communicatively coupled with the computer system to allow trainees to “drive” the artillery unit to and from various locations within a training environment. When trainees move the artillery unit using this external simulation system 125, location data from external simulation system 125 may be provided to ROVER application 115, which may then automatically update a location of the artillery unit within control panel emulator 110.

Similarly, other external simulation systems 125 may comprise physical components devices capable of providing more immersive training for reloading ammunition (e.g. using physical components), inputting crypto (e.g., using a personal data assistant (PDA) similar to the PDA used in the field), and/or other functions related to the artillery unit. Data from external simulation system(s) 125 may be sent to and used by ROVER application 115 to automatically update control panel emulator 110. Data from control panel emulator 110 affecting the operation of external simulation system(s) 125 may be provided to external simulation system(s) 125 by ROVER application 115 and a similar manner. (e.g., when a trainee fires a round using control panel emulator 110, ROVER application 115 can provide this information to an external simulation system 125 that simulates reloading, allowing trainees to reload the chamber from which the round was shot.) That said, in some embodiments, one or more of these simulation systems may be incorporated into and/or executed by training computer system 105.

In some embodiments, data may be provided to ROVER application 115 in the form of a 3D model of the artillery vehicle. In other words, a 3D digital model of the artillery unit may be used in a visual simulation (which may be rendered, for example, in Unreal®, Unity®, or Virtual Battlespace 3 (VBS3)). Changes to the model (e.g., position of vehicle, movement of vehicle, position of launch module, movement of launch module, etc.) made by collective training environment 135 and/or external simulation system(s) 125 can be relayed to ROVER application 115, which may automatically update control panel emulator 110 to reflect these changes.

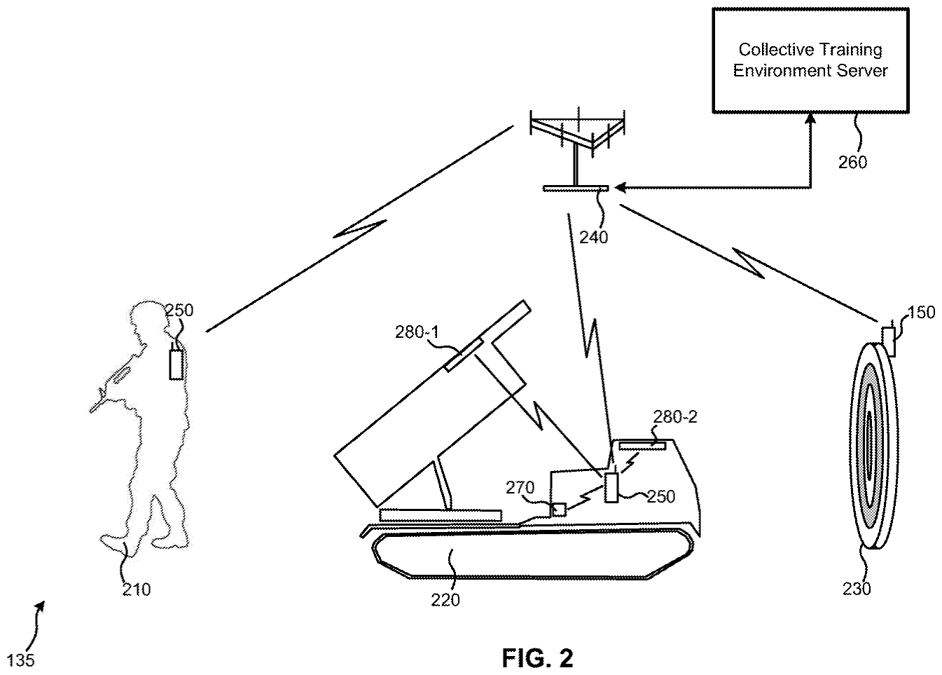

FIG. 2 is a simplified illustration of collective training environment 135, which may correspond to a tactical engagement simulation (TES), according to some embodiments. As discussed herein below, collective training environment 135 may be capable of providing training in a field exercise involving multiple types of entities, such as soldiers 210, rocket/missile artillery units 220 (e.g., MLRS, HIMARS, and/or similar systems), targets 230, and/or other entities, such as non-rocket/missile artillery, vehicles, weapons, equipment, buildings, etc. Rather than live ammunition, the training in collective training environment 135 may comprise a “dry” training in which laser transmitters (e.g., Multiple Integrated Laser Engagement System (MILES)) and/or other equipment is used to simulate the firing of weaponry. Moreover, the various entities in collective training environment 135 can communicate wirelessly via LTE (or similar wireless technology) to a base station 240, using a military communications unit 250, and base station 240 can communicate between the various entities and a collective training environment server 260.

It can be noted that, to purposed of clarity, FIG. 2 illustrates one soldier 210, rocket/missile artillery unit 220, and one target 230. However, a person of ordinary skill in the art will appreciate that training within collective training environment 135 may have any number of each entity type (including no entities of a certain type). For example, in a given training, collective training environment 135 may comprise dozens, hundreds, or even thousands (or more) of soldiers 210, rocket/missile artillery units 220, targets 230, and/or other entities. Moreover, embodiments additionally or alternatively may include any number of base stations 240.

In brief, each military entity 210, 220, and 230 may be provided with a military communications unit 250 capable of communicating with collective training environment server 260 via base station 240. As previously noted, wireless communication may utilize a high-bandwidth digital communication standards, such as LTE or other cellular technologies, thereby giving the military communication system a very high throughput capacity, relative to traditional techniques. (In the case of LTE, base station 240 would comprise a eNodeB (eNB).) Moreover, utilization of LTE or similar technologies can enable the collective training environment to utilize non-line-of-sight systems.

Collective training environment server 260 may comprise one or more computer servers configured to gather information from the various entities within collective training environment 135 and provide information regarding the training in real-time and/or post hoc in After-Action Review (AAR). The information gathered from the various entities within collective training environment 135 may include, for example, status information (e.g., whether the entity is “killed” or “injured”, location and/or orientation information, etc.), information specific to an entity type (e.g., remaining fuel/ammunition, whether a weapon or equipment is deployed/armed, etc.), engagement information (e.g., whether it has engaged and/or has been engaged by other entities), and the like. The information provided by collective training environment server 260 may include any of a variety of analytics and/or visual simulations.

In some embodiments, for example, collective training environment server 260 may provide analytical information to simulation supervisors to determine whether individual entities performed as commanded, the effectiveness of overall strategies, how different entities may interact, and so forth. Again, this analytical information may be provided in real-time or post hoc.

In some embodiments, for example, collective training environment server 260 may provide a 3D computer-simulated visualization of a “virtual” battlefield populated by 3D visualizations of the various entities within collective training environment 135. In some embodiments, entities within the collective training environment 135 may be provided with a simulated visualization of the virtual battlefield in real time. That is, soldiers 210 and/or other entities training in collective training environment 135 may be equipped with a display (e.g., capable of providing an augmented reality (AR), mixed reality (MR), virtual reality (VR), or a similar visualization) showing a visualization, which may be overlaid on a corresponding physical entity in collective training environment 135.

In some embodiments, rocket/missile artillery units 220 may be equipped with TES Acoustic Rocket and Missile Offensive Support System (TES ARMOSS), comprising devices that enable integration into collective training environment 135. TES ARMOSS comprises a vibration sensor 270, orientation sensors 280-1 and 280-2 (collectively and generically referred to herein as orientation sensors 280), and a military communications unit 250. By leveraging-off the platform's immediate pre-firing vibrational signature, the vibration sensor 270 (e.g., a microphone or piezoelectric sensor) may “listen” for the increased vibrational signature of the servos locking-out when the “ARM” switch of the rocket/missile artillery unit 220 is activated and then inform the military communications device 250 that the launcher is “engaged.” Military communications unit 250 in turn can blend engagement with orientation (e.g., orientation of the launch module from launch module orientation sensor 280-1 and optionally orientation of rocket/missile artillery units 220 from vehicle orientation sensor 280-2) and then pass engagement data to collective training environment server 260.

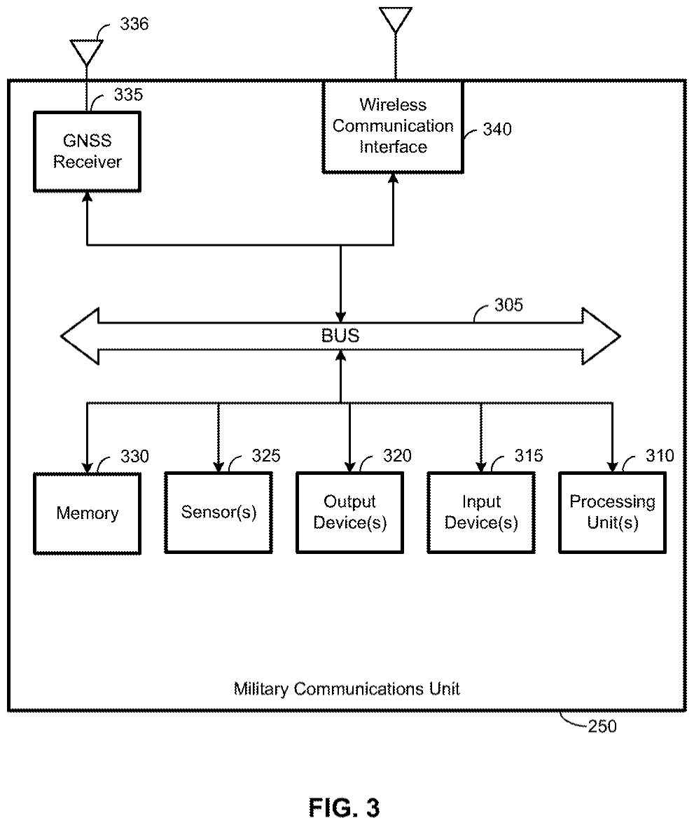

FIG. 3 is a simplified block diagram of the internal components of military communications unit 250, according to some embodiments. As with other figures provided herein, it will be understood that alternative embodiments may comprise alternative configurations of the components, and may add, omit, combine, separate, and/or otherwise alter components, depending on desired functionality. Military communications unit 250 may comprise a military design meeting military-grade standards, thereby configured to withstand higher levels of physical impacts, temperature extremes, and/or other environmental hazards than a consumer device. Nonetheless, a consumer-grade design and/or design met to meet other standards may be used if so desired. It will be understood that military communications unit 250 may comprise other electrical components (e.g., a battery or other power source) not illustrated in FIG. 3.

The various hardware components (components labeled 310-340) of military communications unit 250 can be electrically coupled via a bus 305 (or may otherwise be in communication, as appropriate). The hardware elements may include a processing unit(s) 310 which may comprise without limitation one or more general-purpose processors, one or more special-purpose processors (e.g., application specific integrated circuits (ASICs), and/or the like), reprogrammable circuitry, and/or other processing structure or means, which can be configured to cause military communications unit 250 to perform the functionality described herein. Military communications unit 250 also may comprise one or more input devices 315, which may comprise without limitation one or more touch screens, touch pads, buttons, dials, switches, and/or the like; and one or more output devices 320, which may comprise without limitation, one or more displays, light emitting diodes (LEDs), speakers, and/or the like. In military applications, input device(s) 315 and/or output device(s) 320 may be limited, in comparison with consumer devices such as smartphones. For example, in some embodiments, input device(s) 315 may be limited to a power switch and navigation buttons, and output device(s) 320 may be limited to a small, low power display. In some embodiments, military communications unit 250 may comprise a Universal Serial Bus (USB) port for data communication and/or battery charging.

In some embodiments, military communications unit 250 may comprise one or more sensors 325, which may comprise, for example, one or more accelerometers, gyroscopes, magnetometers, altimeters, proximity sensors, light sensors, and the like. In some embodiments, sensor(s) 325 may comprise an IMU. Sensor(s) 325 may be utilized, for example, to provide orientation and/or movement information regarding the launch module or vehicle of rocket/missile artillery unit 220 (depending on the location of sensor(s) 325 with regard to rocket/missile artillery unit 220) and as such, may functionally replace the launch module orientation sensor 280-1 or vehicle orientation sensor 280-2. Additionally or alternatively, sensor(s) 325 may provide information for dead reckoning and/or other location determination techniques, which may be used to complement wireless positioning performed using data from Global Navigation Satellite System (GNSS) receiver 335 and/or wireless communication interface 340.

According to some embodiments, military communications unit 250 may comprise a GNSS receiver 335 capable of receiving signals from one or more GNSS satellites using a GNSS antenna 336, and determining a location of rocket/missile artillery unit 220. GNSS receiver 335 may support measurement of signals from satellites of a GNSS system, such as Global Positioning System (GPS), Galileo, GLONASS, Quasi-Zenith Satellite System (QZSS), Indian Regional Navigational Satellite System (IRNSS) and/or other Satellite Positioning Systems (SPSes). Ultimately, GNSS receiver 335 may determine a position of the rocket/missile artillery unit 220 using any combination of one or more global and/or regional navigation satellite systems, augmentation systems, and/or other positioning/navigation systems.

Military communications unit 250 may also include a wireless communication interface 340, which may comprise any number of hardware and/or software components for wireless communication. Such components may include, for example, a modem, a network card, an infrared communication device, a wireless communication device, and/or a chipset (e.g., components supporting Bluetooth, IEEE 802.11 (including Wi-Fi), IEEE 802.15.4 (including Zigbee), WiMAX™, cellular communication, etc.), and/or the like, which may enable military communications unit 250 to wirelessly communicate with the various components illustrated in FIG. 2. To enable this functionality, wireless communication interface 340 may comprise various transceivers, and may communicate using commercial cellular and/or traditional military frequency bands, using one or more wireless RF technologies.

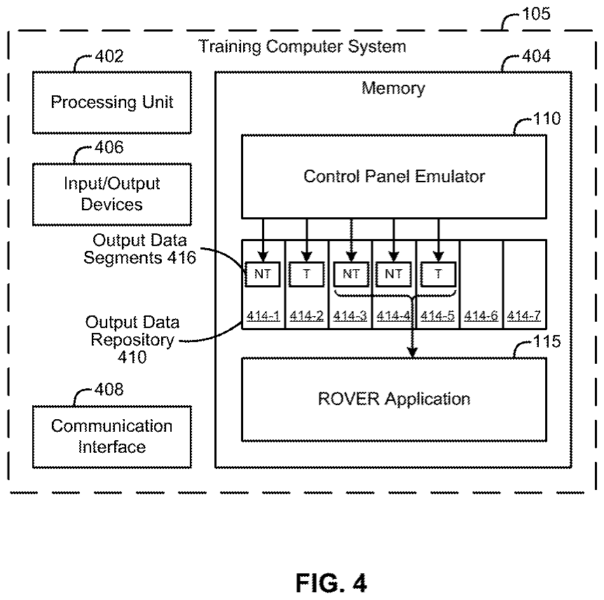

FIG. 4 is a simplified illustration of training computer system 105, according to some embodiments. Training computer system 105 may include a processing unit 402, a memory 404, input/output devices 406, and a communication interface 408. Processing unit 402 may comprise one or more general-purpose processors, one or more special-purpose processors (e.g., application specific integrated circuits (ASICs), and/or the like), reprogrammable circuitry, and/or other processing structure or means, which can be configured to cause training computer system 105 to perform the functionality described herein. Input/Output devices 406 may comprise one or more input devices such as touch screens, touch pads, buttons, dials, switches, and/or the like; and one or more output devices such as displays, LEDs, speakers, and/or the like.

Communication interface 408 may comprise any number of hardware and/or software components for wireless or wired communication. Such components may include, for example, a modem, a network card, an infrared communication device, a wireless communication device, and/or a chipset (e.g., components supporting Bluetooth, IEEE 802.11 (including Wi-Fi), IEEE 802.15.4 (including Zigbee), WiMAX™, cellular communication, etc.), and/or the like. Communication interface 408 may enable training computer 105 to communicate with the various components illustrated in FIG. 1. To enable this functionality, communication interface 408 may comprise various transceivers, and may communicate using commercial cellular and/or various frequency bands using one or more wireless RF technologies.

In some embodiments, control panel emulator 110 may be configured to generate output data segments 416 and write them to locations 414 of an output data repository 410 of memory 404. Locations 414 may correspond to different regions of memory 404 such as to different files and/or to different lines or sections of a text file. Output data repository 410 may be accessible to processing unit 402 such that control panel emulator 110 and ROVER application 115, which may be executed on processing unit 402, may write to and/or read from output data repository 410.

Each of output data segments 416 may, in some embodiments, correspond to data generated by control panel emulator 110 over a given period of time, over a defined set of operations, or over a given size of output data. For example, control panel emulator 110 may be configured to generate a different output data segment 416 every 10 ms, 50 ms, 100 ms, 500 ms, 1 second, 2 seconds, or the like, which are sequentially written to different locations 414 of output data repository 410.

In the illustrated example, control panel emulator 110 generates 5 different output data segments 416 and writes the segments to 5 different locations 414. For example, a first output data segment 416 that does not contain a trigger event (No Trigger “NT”) is written to a first location 414-1, a second output data segment 416 that contains a trigger event (Trigger “T”) is written to a second location 414-2, a third output data segment 416 that does not contain a trigger event is written to a third location 414-3, a fourth output data segment 416 that does not contain a trigger event is written to a fourth location 414-4, and a fifth output data segment 416 that contains a trigger event is written to a fifth location 414-5.

Upon output data segments 416 being written, or at predetermined intervals, ROVER application 115 may read output data segments 416 at locations 414 and examine the output data segments to determine whether each contains a trigger event. Upon identifying a trigger event, ROVER application 115 may extract details regarding the trigger event from output data segments 416 that are related to the particular output data segment 416 that contains the trigger event. For example, ROVER application 115 may read output data segment 416 at location 414-3 and determine that it does not contain a trigger event. Next, ROVER application 115 may read output data segment 416 at location 414-4 and determine that it also does not contain a trigger event. Next, ROVER application 115 may read output data segment 416 at location 414-5 and determine that it contains a trigger event. In response to identifying the trigger event, ROVER application 115 may determine that output data segments 416 at locations 414-3 and 414-4 are related to output data segment 416 at location 414-5 that contains the trigger event, and may accordingly extract details regarding the trigger event from one or more of output data segments 416 at locations 414-3, 414-4, and 414-5.

For example, output data segment 416 at location 414-5 may include an indication of a simulated firing of the artillery unit while output data segments 416 at locations 414-3 and 414-4 may include the type of round fired during the simulated firing, the number of rounds fired during the simulated firing, the amount and/or type of charge used in the simulated firing, the orientation of the barrel of the artillery unit, the location of the artillery unit, the time of the simulated firing, and the like. In some embodiments, output data segment 416 at location 414-2 may be disregarded for the trigger event at output data segment 416 at location 414-5 since output data segment 416 at location 414-2 also contains a trigger event. Accordingly, ROVER application 115 is able to intelligently gather information from output data repository 410 in a timely matter so as to provide integration between control panel emulator 110 and collective training environment 135 as well as with other components of artillery unit training system 100.

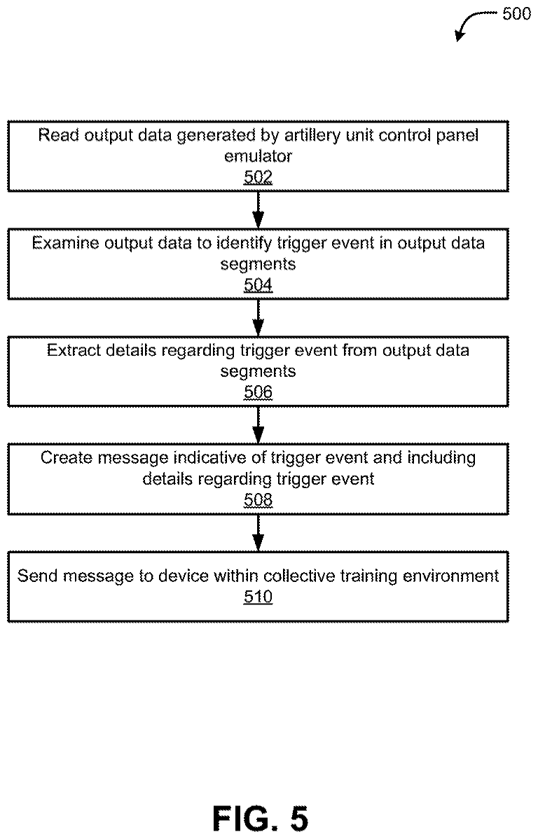

FIG. 5 is a flow diagram of a method 500 of interfacing an artillery unit control panel emulator (e.g., control panel emulator 110) with a collective training environment (e.g., collective training environment 135), according to some embodiments. Alternative embodiments may vary in function by combining, separating, or otherwise varying the functionality described in the blocks illustrated in FIG. 5. Means for performing the functionality of one or more of the blocks illustrated in FIG. 5 may comprise one or more components of a training computer system, such as components of the embodiment of training computer system 105 illustrated in FIGS. 1 and 4. Such means may further include software means, which may be executed by one or more processing units (e.g., processing unit 402 of FIG. 4).

At block 502, the method comprises reading output data generated by the artillery unit control panel emulator. In some embodiments, the output data includes one or more output data segments (e.g., output data segments 416). In some embodiments, the artillery unit control panel emulator is associated with a rocket or missile artillery unit (e.g., rocket/missile artillery units 220). In some embodiments, the artillery unit control panel emulator is operated on a training computer system (e.g., training computer system 105) that includes a processing unit (e.g., processing unit 402) communicatively coupled to a memory (e.g., memory 404) and a communication interface (e.g., communication interface 408). In some embodiments, the output data is read from an output data repository 410 of the training computer system.

At block 504, the method comprises examining the output data to identify a trigger event in the one or more output data segments. In various embodiments, the trigger event comprises a simulated arming of an artillery unit, a simulated firing of the artillery unit, or a detonation of a round based on the simulated firing of the artillery unit.

At block 506, the method comprises extracting details regarding the trigger event from the one or more output data segments. In some embodiments, extracting the details regarding the trigger event from the one or more output data segments is performed in response to identifying the trigger event. In some embodiments, the details regarding the trigger event are extracted prior to identifying the trigger event. In some embodiments, the details regarding the trigger event may include the type of round fired during the simulated firing, the number of rounds fired during the simulated firing, the amount and/or type of charge used in the simulated firing, the orientation of the barrel of the artillery unit, the location of the artillery unit, the time of the simulated firing, and the like.

At block 508, the method comprises creating a message indicative of the trigger event and including the details regarding the trigger event. The message may indicate that the trigger event was identified and may further include or more of the details regarding the trigger event described in reference to block 506 (e.g., the orientation and/or location of the artillery unit, the time of the simulated firing, and the like). In some embodiments, the message comprises a distributed interactive simulation (DIS) message.

At block 510, the method comprises sending, via the communication interface, the message to a device within the collective training environment. In some embodiments, the device within the collective training environment is a collective training environment server (e.g., collective training environment server 260).

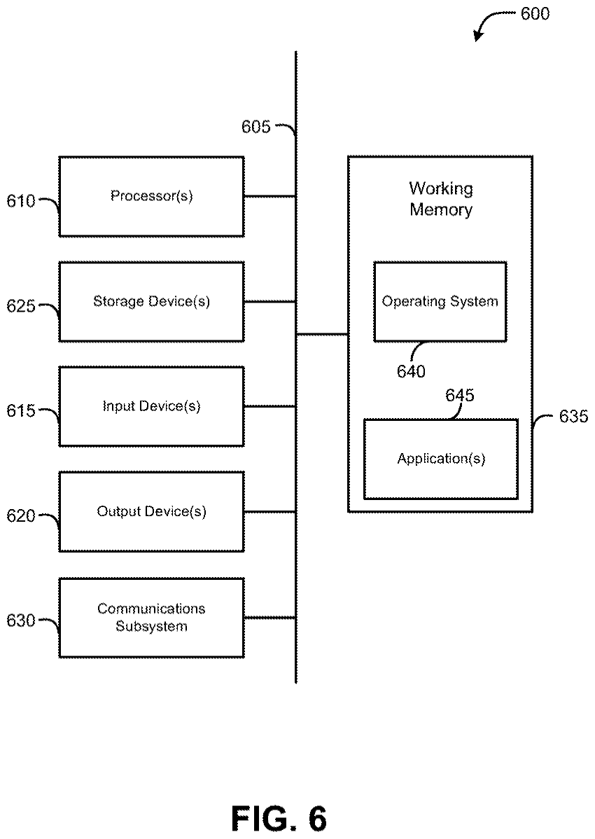

FIG. 6 is a simplified block diagram of a computer system 600, according an embodiment. A computer system 600 as illustrated in FIG. 6 may, for example, may correspond with and/or be integrated into one or more components of artillery unit training system 100. FIG. 6 provides a schematic illustration of one embodiment of a computer system 600 that can perform some or all of the steps of the methods provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605, or may otherwise be in communication, as appropriate. The hardware elements may include one or more processors 610, including without limitation one or more general-purpose processors (e.g., CPUs) and/or one or more special-purpose processors such as digital signal processing chips, graphics acceleration processors (e.g., GPUs), and/or the like; one or more input devices 615, which can include without limitation a mouse, a keyboard, a camera, a touchscreen, a physical control (steering wheel, pedal, etc.) and/or the like; and one or more output devices 620, which can include without limitation a display device and/or the like.

The computer system 600 may further include and/or be in communication with one or more non-transitory storage devices 625, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 600 might also include a communication interface 630, which can include without limitation a modem, a network card (wireless or wired), an infrared communication device, a wireless communication device, and/or a chipset, and/or the like. The communication interface 630 may include one or more input and/or output communication interfaces to permit data to be exchanged with other computer systems and/or any other devices described herein.

The computer system 600 also can include software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, all or part of one or more procedures described with respect to the methods discussed above, and/or methods described in the claims, might be implemented as code and/or instructions executable by a computer and/or a processor within a computer. In an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 625 described above. In some cases, the storage medium might be incorporated within a computer system, such as computer system 600. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 600 to perform methods in accordance with various embodiments of the technology. According to a set of embodiments, some or all of the procedures of such methods are performed by the computer system 600 in response to processor(s) 610 executing one or more sequences of one or more instructions, which might be incorporated into the operating system 640 and/or other code, such as an application program 645, contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 625. Volatile media include, without limitation, dynamic memory, such as the working memory 635.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communication interface 630 and/or components thereof generally will receive signals, and the bus 605 then might carry the signals and/or the data, instructions, etc. carried by the signals to the working memory 635, from which the processor(s) 610 retrieves and executes the instructions. The instructions received by the working memory 635 may optionally be stored on a non-transitory storage device 625 either before or after execution by the processor(s) 610.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups. As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A method of interfacing an artillery unit control panel emulator with a collective training environment, the method comprising:
reading output data generated by the artillery unit control panel emulator, wherein the output data includes one or more output data segments;
examining the output data to identify a trigger event in the one or more output data segments;
extracting details regarding the trigger event from the one or more output data segments;
creating a message indicative of the trigger event and including the details regarding the trigger event; and
sending, via a communication interface, the message to a device within the collective training environment.

2. The method of claim 1, wherein the trigger event comprises at least one of:
a simulated arming of an artillery unit,
a simulated firing of the artillery unit; or
a detonation of a round based on the simulated firing of the artillery unit.

3. The method of claim 1, wherein the device within the collective training environment is a collective training environment server.

4. The method of claim 1, wherein the artillery unit control panel emulator is associated with a rocket or missile artillery unit.

5. The method of claim 1, wherein the artillery unit control panel emulator is executed on a training computer system that includes a processing unit communicatively coupled to a memory and the communication interface, wherein the training computer system is separate from the device within the collective training environment.

6. The method of claim 1, wherein extracting the details regarding the trigger event from the one or more output data segments is performed in response to identifying the trigger event.

7. The method of claim 1, wherein the output data is read from an output data repository of a training computer system on which the artillery unit control panel emulator is executed.

8. The method of claim 1, wherein the message comprises a distributed interactive simulation (DIS) message.

9. The method of claim 1, further comprising:
receiving, via the communication interface, information from a second device separate from a training computer system on which the artillery unit control panel emulator is executed; and
updating information within the artillery unit control panel emulator based, at least in part, on the information received from the second device.

10. A training computer system for interfacing an artillery unit control panel emulator with a collective training environment, the system comprising:
a communication interface;
a memory; and
a processing unit communicatively coupled with the memory and the communication interface and configured to perform operations comprising:
reading output data generated by the artillery unit control panel emulator, wherein the output data includes one or more output data segments;
examining the output data to identify a trigger event in the one or more output data segments;
extracting details regarding the trigger event from the one or more output data segments;
creating a message indicative of the trigger event and including the details regarding the trigger event; and
sending, via the communication interface, the message to a device within the collective training environment.

11. The training computer system of claim 10, wherein the trigger event comprises at least one of:
a simulated arming of an artillery unit,
a simulated firing of the artillery unit; or
a detonation of a round based on the simulated firing of the artillery unit.

12. The training computer system of claim 10, wherein the device within the collective training environment is a collective training environment server.

13. The training computer system of claim 10, wherein extracting the details regarding the trigger event from the one or more output data segments is performed in response to identifying the trigger event.

14. The training computer system of claim 10, wherein the message comprises a distributed interactive simulation (DIS) message.

15. The training computer system of claim 10, wherein the operations further comprise:
receiving, via the communication interface, information from a second device separate from a training computer system on which the artillery unit control panel emulator is executed; and
updating information within the artillery unit control panel emulator based, at least in part, on the information received from the second device.

16. A non-transitory computer-readable medium comprising instructions for interfacing an artillery unit control panel emulator with a collective training environment, wherein the instructions, when executed by one or more processors, cause the one or more processors to perform operations comprising:
reading output data generated by the artillery unit control panel emulator, wherein the output data includes one or more output data segments;
examining the output data to identify a trigger event in the one or more output data segments;
extracting details regarding the trigger event from the one or more output data segments;
creating a message indicative of the trigger event and including the details regarding the trigger event; and
sending, via a communication interface, the message to a device within the collective training environment.

17. The non-transitory computer-readable medium of claim 16, wherein the trigger event comprises at least one of:
a simulated arming of an artillery unit,
a simulated firing of the artillery unit; or
a detonation of a round based on the simulated firing of the artillery unit.

18. The non-transitory computer-readable medium of claim 16, wherein the device within the collective training environment is a collective training environment server.

19. The non-transitory computer-readable medium of claim 16, wherein the message comprises a distributed interactive simulation (DIS) message.

20. The non-transitory computer-readable medium of claim 16, wherein the operations further comprise:
receiving, via the communication interface, information from a second device separate from a training computer system on which the artillery unit control panel emulator is executed; and
updating information within the artillery unit control panel emulator based, at least in part, on the information received from the second device.
